(19) United States
(12) Patent Application Publication
(10) Pub. No.: US 2025/0384474 A1
(43) Pub. Date: Dec. 18, 2025

(54) MARKETPLACE FOR SECONDARY SALES OF AUTHENTICATED PHYSICAL GOODS

(71) Applicant: ghostwarp co., West Roxbury, MA (US)

(72) Inventors: Bennett COLLEN, West Roxbury, MA (US); Wayne NILSEN, Amherst, NH (US)

(73) Assignee: ghostwarp co., West Roxbury, MA (US)

(21) Appl. No.: 19/236,643

(22) Filed: Jun. 12, 2025

Related U.S. Application Data
(60) Provisional application No. 63/659,612, filed on Jun. 13, 2024.

(51) Int. Cl. G06Q 30/0601; G06Q 30/018

(52) U.S. Cl. CPC G06Q 30/0609; G06Q 30/0185

(57) ABSTRACT

A computer-implemented method for listing a physical object on a marketplace is provided. The method includes receiving an identifier associated with the physical object to be listed, wherein the identifier is obtained by scanning the physical object. The method includes transmitting a validation request message comprising the identifier. The method includes receiving a validation response message, wherein the validation response message includes an indication of whether the physical object is authentic. The method includes, if the physical object is indicated as being authentic: obtaining first descriptive information associated with the physical object; and generating a listing for the physical object on the marketplace based on the first descriptive information. The method includes, if the physical object is indicated as not being authentic, not generating a listing for the physical object on the marketplace.

### CROSS REFERENCE TO RELATED APPLICATIONS

This application claims priority to U.S. provisional patent application No. 63/659,612, filed on Jun. 13, 2024. The above identified application is incorporated herein by this reference.

### TECHNICAL FIELD

Disclosed are embodiments related to the sale of secondary physical goods on a marketplace. More particularly, this disclosure relates to computer-implemented methods and apparatuses for listing physical goods with unique identifiers on a marketplace.

### BACKGROUND

A secondary marketplace for used goods allows users to sell their possessions directly to other users of the marketplace. Current online marketplaces for secondary sales face several significant challenges that limit their effectiveness and user experience. A first issue is the lack of reliable and efficient methods for authenticating products. Counterfeit and fraudulent items are prevalent on online marketplaces, eroding trust between buyers and sellers. This lack of trust can lead to hesitation among potential buyers, reducing overall sales volume, and hindering the growth of the secondary market.

Another key problem is that listing products on the online marketplace is time-consuming and often leads to inaccurate product listings. Marketplaces may require sellers to manually input product details, specifications, and images, which can be a tedious and error-prone task. This can result in inconsistent, incomplete, or misleading listings, making it difficult for buyers to make informed purchasing decisions. Additionally, the manual listing process can discourage potential sellers from listing their items, reducing the overall inventory available on the platform.

Furthermore, traditional online marketplaces often struggle with user experience issues, such as limited product information. These factors can lead to frustration among users, resulting in reduced engagement and lower transaction volumes. In existing marketplaces, the original brand that created the product doesn't participate in the upside of any secondary sale of the good. The original brand has no way of knowing when their goods change hands on the secondary market. As such, the original brands miss out on secondary sales revenue and cannot establish a relationship with secondary buyers. Instead, the secondary buyer is a customer of the secondary marketplace. Additionally, existing marketplaces take a large percentage of sales from customers as a fee, which they typically justify for performing the service of authentication, which they do manually, slowly, and imperfectly. As a result, buyers experience a slow, inefficient buying process, where the product they purchased is shipped to an intermediary before they receive it. This has a negative environmental impact, the buyer has no relationship with original brand, and the buyer may be uncertain of the product's authenticity.

### SUMMARY

Existing solutions attempting to address the issues faced by online marketplaces for secondary sales have their own limitations and drawbacks. In an online consignment model, a marketplace platform takes custody of the items, authenticates, and grades them in-house. While this approach can help ensure product authenticity, it comes with significant costs and operational overhead. Online consignment models can result in take rates as high as 70%, which is unsustainable for many sellers and limits the platform's scalability.

Another existing solution is a model which focuses exclusively on “deadstock” or brand new, unused items. This model may rely heavily on the reputation of the marketplace for authentication, with items being shipped to their facilities for inspection and verification of product condition before being sent to the final buyer. While this method can help maintain product integrity, it also involves substantial overhead costs and high take rates, similar to the online consignment model. This approach limits the platform's ability to expand beyond a niche market and cater to a broader range of secondary sales.

To effectively overcome the limitations of current online marketplaces for secondary sales, a more innovative and technology-driven approach is necessary. By leveraging advances in NFC technology, automation, and data management, it is possible to create a platform that improves and streamlines the authentication process, simplifies listing creation, and enhances the user experience while maintaining cost-effectiveness and scalability. Addressing these issues can unlock the full potential of online marketplaces, benefiting both buyers and sellers while contributing to a more sustainable and thriving circular economy.

An advantage of embodiments disclosed herein is that they integrate NFC technology into a marketplace platform and improve the ability to authenticate products through their NFC chips. This helps to combat counterfeiting and fraud, which are major concerns in online marketplaces, and in sales of secondary goods more broadly. This increased trust and transparency encourages more people to participate in secondary sales, knowing that the products they are purchasing are genuine.

Another advantage of embodiments disclosed herein is that they improve the product listing process by using NFC chips to pre-populate product details from a comprehensive catalog, dramatically simplifying the listing process for sellers. By electronically and automatically filling in key information such as brand, model, specifications, and images, sellers can create accurate and attractive listings with minimal effort. This not only saves time but also ensures consistency and quality across the platform, enhancing the overall user experience.

The improved trust, convenience, and user experience offered by the embodiments disclosed herein may attract a larger user base and increase transaction volumes within the secondary sales market. As more people embrace the platform, it can contribute to the growth of the circular economy, promoting sustainability by extending the life cycle of products and reducing waste. Furthermore, the embodiments disclosed herein can be adapted and applied to other industries where authentication and product information management are crucial, such as luxury goods and collectibles.

Another advantage of embodiments disclosed herein is that they improve the secondary marketplace experience for brands, sellers, and buyers. Brands can verify that their goods sold on the secondary marketplace are authentic and can establish a relationship with secondary buyers. Embodiments disclosed herein also enable brands to capture secondary royalties on the sale of their goods. Additionally, sellers can authenticate their goods without shipping the goods to a third party for inspection. This lowers the transaction cost allowing the seller to keep a larger percentage of the sale price. Embodiments described herein also provide a frictionless listing process for sellers and enable sellers to list their goods with more complete product information. For buyers, they may receive their purchases faster as there is no third-party entities between the seller and buyer. This also allows for the transaction to have a smaller environmental footprint. Embodiments described herein also provide complete transparency, proving product provenance and authenticity. This enables buyers to establish a relationship with brands and have access to additional information when making a purchase.

Another advantage of embodiments disclosed herein is the ability to maintain chain-of-ownership data and compliance information for each physical object throughout its lifecycle. The marketplace may securely store and share an item's provenance information by updating ownership records upon each transfer of the item. Maintaining ownership records may bolster consumer trust and simplify brand or insurance verifications. Additionally, storing compliance and regulatory data throughout an item's lifecycle allows the marketplace to facilitate recalls, verify warranties, and ensure continuing regulatory adherence during each subsequent resale.

According to a first aspect, a computer-implemented method for listing a physical object on a marketplace is provided. The method includes receiving an identifier associated with the physical object to be listed, wherein the identifier is obtained by scanning the physical object. The method includes transmitting a validation request message comprising the identifier. The method includes receiving a validation response message, wherein the validation response message includes an indication of whether the physical object is authentic. The method includes, if the physical object is indicated as being authentic: obtaining first descriptive information associated with the physical object; and generating a listing for the physical object on the marketplace based on the first descriptive information. The method includes, if the physical object is indicated as not being authentic, not generating a listing for the physical object on the marketplace.

In some embodiments, the computer-implemented method further comprises, prior to receiving the identifier, retrieving the first descriptive information from a third party, wherein the third party is associated with the physical object; and storing the first descriptive information in a database, wherein obtaining the first descriptive information associated with the physical object comprises retrieving the first descriptive information from the database.

In some embodiments, retrieving the first descriptive information from the third party comprises scraping a website associated with the third party. In some embodiments, the validation message is transmitted to a device associated with the third party. In some embodiments, obtaining the first descriptive information comprises: after receiving the validation response message, retrieving the first descriptive information from a third party, wherein the third party is associated with the physical object.

In some embodiments, the computer-implemented method further comprises, if the physical object is indicated as being authentic: transmitting a request for second descriptive information; receiving the second descriptive information; and including the second descriptive information in the listing.

In some embodiments, the second descriptive information comprises a price, a condition of the physical object, and an image of the physical object.

In some embodiments, the computer-implemented method further comprises receiving a modification request, wherein the modification request indicates a modification to the listing.

In some embodiments, the physical object includes a near-field communication (NFC) chip and the identifier is obtained by a computing device scanning the NFC chip of the physical object. In some embodiments, the validation response message includes a unique unit identifier.

In some embodiments, the computer-implemented method further comprises determining whether another listing is associated with the unique unit identifier.

According to a second aspect, a system for listing a physical object on a marketplace is provided. The system includes a database; a controller, wherein the controller is configured to: retrieve first descriptive information associated with the physical object from a third party, wherein the third party is associated with the physical object; and store the first descriptive information in the database. The system includes an application programming interface (API), where in the API is configured to: receive an identifier associated with the physical object to be listed, wherein the identifier is obtained by scanning the physical object; transmit a validation request message comprising the identifier; receive a validation response message, wherein the validation response message includes an indication of whether the physical object is authentic; if the physical object is indicated as being authentic: obtain the first descriptive information associated with the physical object from the database; and generate a listing for the physical object on the marketplace based on the first descriptive information; and, if the physical object is indicated as not being authentic, not generate a listing for the physical object on the marketplace.

In a third aspect, a device used for listing a physical object on a marketplace is provided. The device includes one or more memories comprising instruction data representing a set of instructions; and one or more processors configured to communicate with the one or more memories and to execute the set of instructions, wherein the set of instructions, when executed by the processor, cause the one or more processors to perform the methods of the first aspect.

In a fourth aspect, a computer program is provided. The computer program includes instructions which, when executed by processing circuitry, causes the processing circuitry to carry out the methods of the first aspect.

In a fifth aspect, a carrier containing a computer program according to the fourth aspect is provided. The carrier comprises one of an electronic signals, optical signal, radio signal or computer readable storage medium.

In a sixth aspect, a computer program product comprising a non-transitory computer readable medium having stored thereon a computer program according to the fourth aspect is provided.

In a seventh aspect, an apparatus is provided. The apparatus includes a memory and processing circuitry coupled to the memory, wherein the apparatus is configured to perform the methods of the first aspect.

### BRIEF DESCRIPTION OF THE DRAWINGS

The accompanying drawings, which are incorporated herein and form part of the specification, illustrate various embodiments.

FIG. 1 is a block diagram illustrating an architecture for listing a physical object on a marketplace according to some embodiments.

FIG. 2 is a sequence diagram illustrating a method for listing a physical object on a marketplace according to some embodiments.

FIGS. 3-9 are diagrams illustrating a user interface for listing a physical object according to some embodiments.

FIG. 10 is a flow chart illustrating a process according to some embodiments.

FIG. 11 is a flow chart illustrating a process according to some embodiments.

FIG. 12 is a flow chart illustrating a process according to some embodiments.

FIG. 13 is a block diagram of an apparatus according to some embodiments.

### DETAILED DESCRIPTION

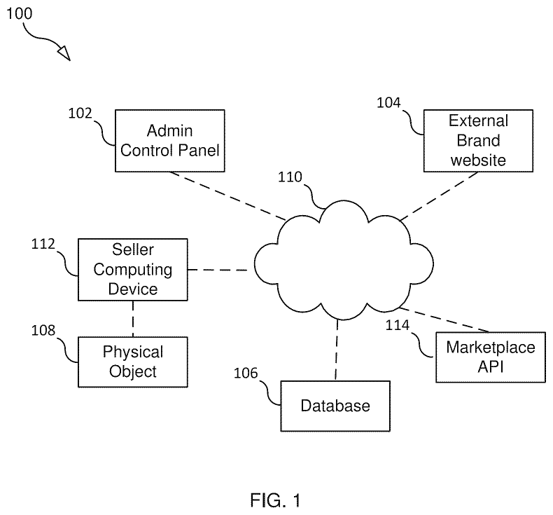

FIG. 1 is a block diagram illustrating an architecture 100 for listing a physical object on a marketplace according to some embodiments. In some embodiments, the marketplace of FIG. 1 is for the secondary sale of physical goods containing NFC chips. Architecture 100 leverages the capabilities of NFC technology to revolutionize the way people buy and sell pre-owned items online, addressing the limitations of traditional marketplaces. By utilizing the data stored in NFC chips embedded within products, Architecture 100 streamlines the listing process, enhances product authentication, and provides a superior user experience for both buyers and sellers. As described below, users of the marketplace can authenticate their goods, which facilitates peer-to-peer transactions over the marketplace.

Architecture 100 comprises an admin control panel 102 which serves as a centralized interface for platform administrators to manage various aspects of architecture 100. Admin control panel 102 allows administrators to monitor user activity, moderate listings on the marketplace, and handle customer support issues. Additionally, admin control panel 102 enables the management of a product catalog, including adding, updating, and removing product information.

The product catalog may be embodied as a list of physical objects and descriptive information describing the physical objects. Each physical object may be associated with an NFC identifier. For example, the product catalog may include an entry for a wallet which comprises an NFC identifier associated with the wallet and descriptive information (e.g., color of the wallet, designer, category). Admin control panel 102 may obtain the data associated with a physical object from an external brand website 104 and store the data in database 106.

External brand website 104 may be embodied as an online store or ecommerce platform of a brand that sells products containing NFC chips. External brand website 104 may share product information, specifications, and images of the products with admin control panel 102. Before or during a product listing process on the marketplace, the relevant product data is transferred from external brand website 104, ensuring accurate and up-to-date information for buyers. Database 106 is configured to store and organize all the data related to architecture 100, including user information, product details, and transaction records. It ensures data integrity, security, and efficient retrieval of information. Database 106 may serve as the foundation for the functioning of other components, providing a centralized repository for data storage and management.

The components of architecture 100 may perform the methods and processes described herein. The components of architecture 100 may comprise: processing circuitry (PC), which may include one or more processors (P) (e.g., a general purpose microprocessor and/or one or more other processors, such as an application specific integrated circuit (ASIC), field-programmable gate arrays (FPGAs), and the like); a network interface for enabling the components to transmit data to and receive data from other devices connected to a network (e.g., an Internet Protocol (IP) network such as the Internet) to which network interface is connected; and a local storage unit (a.k.a., “data storage system”), which may include one or more non-volatile storage devices and/or one or more volatile storage devices. In embodiments where PC includes a programmable processor, a computer program product (CPP) may be provided. CPP includes a computer readable medium (CRM) storing a computer program (CP) comprising computer readable instructions (CRI). CRM may be a non-transitory computer readable medium, such as, magnetic media (e.g., a hard disk), optical media, memory devices (e.g., random access memory, flash memory), and the like. In some embodiments, the CRI of computer program is configured such that when executed by PC, the CRI causes the components to perform steps described herein (e.g., steps described herein with reference to the flow charts). In other embodiments, the components may be configured to perform steps described herein without the need for code. That is, for example, PC may consist merely of one or more ASICs. Hence, the features of the embodiments described herein may be implemented in hardware and/or software.

A seller wishing to list a physical object 108 (e.g., footwear, such as a pair of sneakers, apparel, equipment, or a functional asset) on the marketplace may use their computer device 112 to interact with a user frontend. The user frontend may be embodied the primary interface for buyers and sellers to interact with the marketplace. It provides a user-friendly and intuitive experience for browsing listings, making purchases, and managing seller accounts. The user frontend may incorporate features such as search functionality, product filters, and user profiles, ensuring that users can easily navigate the platform and find the products they are interested in.

To initiate the listing process, the seller scans the NFC chip on physical object 108 using the seller computing device 112. The user frontend may communicate the scanned information (e.g., NFC identifier) to a marketplace application programming interface (API) 114 utilizing a network 110 (e.g., the internet), which then reaches out to external brand website 104 to verify the authenticity of the product. In some embodiments, information may be obtained from physical object 108 using other information sharing technologies, including, for example, quick-response (QR) codes, barcodes, SnapTags, image recognition, Bluetooth beacons, radio frequency identification (RFID), optical scanning techniques (computer vision, spectral imaging, or magnetic resonance imaging), and/or any other technology that can uniquely identify a physical item. API 114 may facilitate communication and data exchange between different components of architecture 100. It may allow for integration with external systems, such as brand websites, enabling the synchronization of product information. Furthermore, API 114 may enable third-party developers to build applications and services that interact with the marketplace, expanding its functionality and reach. External brand website 104 may serve as a portal for brands to verify and authenticate products listed on the marketplace. Brands may access and validate the information stored in the NFC chips of their products. Through the authentication process integrity and authenticity of products traded on the marketplace is maintained, helping to combat counterfeiting and fraud.

After physical object 108 has been authenticated by external brand website 104, a listing may be generated on the marketplace for physical object 108. The listing may include the descriptive information obtained from database 106. The seller may also be prompted to provide additional information (e.g., price and condition) to the marketplace for the listing. In some embodiments, additional information may be retrieved from external brand website 104 for the listing after physical object 108 has been authenticated.

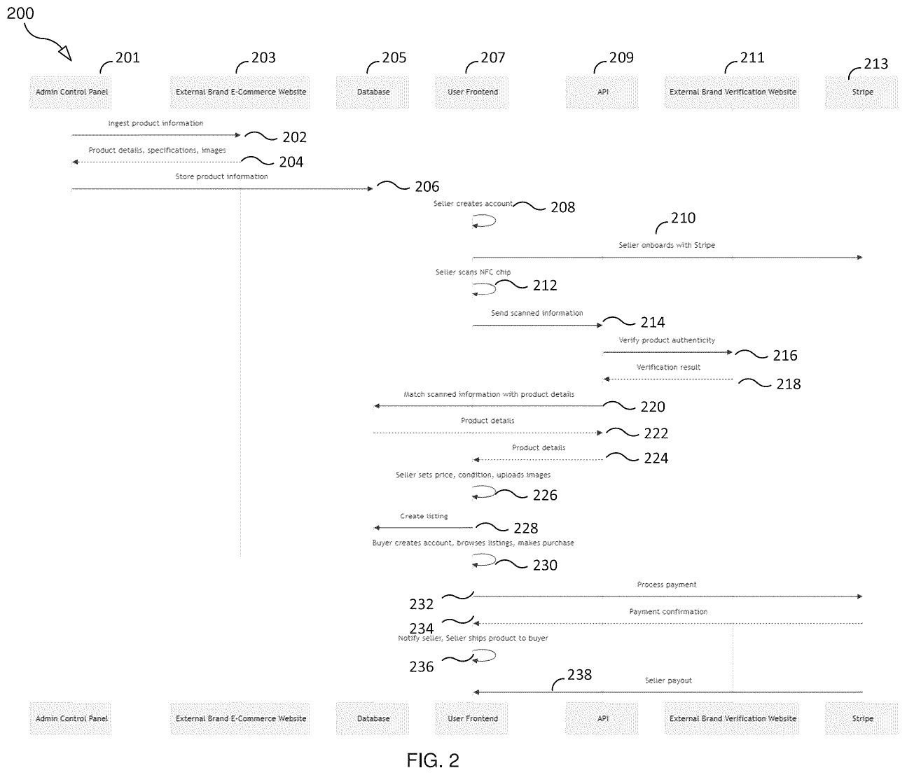

FIG. 2 is a sequence diagram illustrating a method for listing a physical object on the marketplace according to some embodiments. By leveraging the data stored in NFC chips embedded within physical objects, method 200 may verify the authenticity of items listed on the marketplace, setting it apart from traditional authentication methods used by existing marketplaces. Method 200 begins with step 202.

Step 202 comprises admin control panel 201 ingesting product information from external brand e-commerce website 203. The product information may include a list of products offered by the brand along with product details, specifications, and images. In some embodiments, the product information may include a list of NFC identifiers, serial numbers, and/or other unique identifiers associated with each product. Admin control panel 201 may use the product information to build a product catalog for future secondary sales of the brand's products. For example, if the brand of website 203 sells wallets, then the product information for each wallet may include a corresponding NFC identifier included in the wallet's NFC chip, a make and material of the wallet, and the designer of the wallet. Then when a seller wishes to sell the brand's wallet on the marketplace, the marketplace already has accurate descriptive information obtained directly from the brand. In some embodiments, external website 203 may transmit product details periodically to admin control panel 201 updating the product catalog at step 204. Admin control panel 201 may store the product descriptions in database 205 at step 206.

When a seller wants to create a listing for a physical object, they may first create a marketplace account on an user frontend 207 and onboard with a financial provider (e.g., Stripe) 213 at steps 208 and 210. The seller may access user frontend 207 using their personal computing device (e.g., smart phone). Financial provider 213 may handle the financial transactions for the marketplace. Afterwards, to initiate the listing process, the seller scans an NFC chip on the physical object with their personal computing device at step 212. At step 214, user frontend 207 may communicate the scanned information to API 209. The scanned information may include an NFC identifier associated with the physical object and/or product information describing the physical object. After receiving the scanned information, API 209 may determine a brand associated with the physical object and may transmit a validation request message at step 216 to an external brand website 211. The verification request message may include the NFC identifier. In some embodiments, the validation request message comprises at least one of: a request to determine whether there is a digital certificate associated with the physical object, a request to determine whether the digital certificate is authentic, and a request to determine whether a user owns the certificate. In some embodiments, API 209 may determine the brand based on the NFC identifier, scanned information or based on data within database 205.

At step 218, API 209 may receive a validation response message from external website 211. The validation response message may include an indication of whether the physical object is authentic. If the physical object is indicated as not being authentic, a listing for the physical object is not generated. In some embodiments, API 209 may transmit a message to user frontend 207 indicating the authentication has failed when the physical object is not being authentic. If the physical object is indicated as being authentic, then method 200 proceeds to step 220 and begins to generate a listing for the physical object. In some embodiments, the validation response message may include an indication that a digital certificate associated with the physical object is authentic. In some embodiments, the validation response message may include an indication of whether the digital certificate is associated with a seller of the physical object.

In some embodiments, the validation message may authenticate the physical object at a product identification level. Here, the message may indicate the physical object belongs to a category of products or a product line, but it may not specify details of the product, such as size or color. For example, the message may indicate a scanned sneaker is an “Air Jordan” but not provide information about its specific variant.

In some embodiments, the validation message may authenticate the physical object at a product variant identification level. Here, the message may indicate the physical object belongs to a category of products or a product line and the message may also indicate specific variant attributes of the physical object, such as size, color, and other characteristics that may vary by product. For example, the message may indicate a scanned sneaker is a particular model “Air Jordan” (example: Jordan 4) in a particular size and color.

In some embodiments, the validation message may authenticate the physical object at a specific unit identification level. Here, the message indicates a unique unit identifier. The unique unit identifier specifies the exact unit of the physical object, allowing the marketplace to distinguish it from other identical objects. The validation message may also indicate that the physical object belongs to a category of products and comprises specific variant attributes. In some embodiments, API 209 may determine whether the unique unit identifier is already associated with another listing. If so, API 209 may terminate the listing process and transmit an error message to user frontend 207.

The marketplace may use the unique unit identifier to prevent duplicate listings. As an illustrative example, Bob buys a pair of sneakers and creates a listing on the marketplace (Listing 1). Bob then creates another listing for the same pair of sneakers (Listing 2). Alice buys the sneakers from Listing 1, and Bob ships the product to her. In this example, listing 2 now represents a fraudulent listing, as the product has already been sold. By utilizing the unique unit identifier, the marketplace may prevent the second listing as it would recognize that the physical object with that unique unit identifier is already listed. As such, the marketplace may prevent fraudulent activities like the one described above. Integrating unique unit identifiers enhances the ability to maintain the integrity of the marketplace and prevent duplicate or fraudulent listings. At steps 220 and 222, API 209 may obtain descriptive information related to the physical object from database 205. The descriptive information may have been originally stored in the database at step 206. API 209 may locate the descriptive information corresponding to the physical object using the scanned information. In some embodiments, descriptive information may be obtained from external brand website 203 after the physical object has been authenticated. In some embodiments, the descriptive information may correspond to the identification level of the verification message of step 218. For example, if that identification level is at the product identification level, then the descriptive information may include a product line associated with the physical object. As another example, if the identification level is at the product variant identification level or specific unit identification level, the descriptive information may include a product line associated with the physical object and variant attributes associated with the physical object, such as size and color. The descriptive information may then be transmitted to user frontend 207 at step 224 to establish the listing.

At step 226, user frontend 207 may then prompt the seller to set the price, specify the condition of the item, and upload relevant images. Once the seller completes these steps, the listing is created and becomes visible to potential buyers on the marketplace and the listing is logged into database 205 at step 228. The listing may include the information provided by the seller at step 226 and the descriptive information provided by API 209 at step 224.

When a buyer visits the marketplace, they can browse through the available listings. To make a purchase, the buyer creates an account on user frontend 207 at step 230. Upon finding a desired item, the buyer proceeds with the purchase process. The transaction may be facilitated through user frontend 207, with the payment managed by financial provider 213 at steps 232 and 234. After the purchase is complete, the seller is notified and ships the product directly to the buyer at step 236. The seller's payout is handled through financial provider 213, ensuring a secure and efficient transaction process at step 238.

In some embodiments, architecture 100 may be configured to maintain an ownership log for each physical object from the point of manufacture to the most recent sale. The ownership log may be stored in a database (e.g., database 106 and/or database 205). Each time a secondary sale of the physical object occurs, architecture 100 may automatically update the ownership log with the new owner's information providing a comprehensive chain-of-ownership accessible to authorized entities. The ownership log may be used by buyers, sellers, and/or the original brand to verify the authenticity of an item, its historical provenance, prior ownership, and any relevant transaction details.

For example, the marketplace may retrieve the ownership log information and display a physical object's transfer history when an NFC chip in a physical object is scanned. The information displayed may include the most recent date of transfer, the parties involved in the transfer, and references to prior listings, sales, and/or transactions. Such provenance data may significantly increase buyer trust by confirming the physical object's authenticity and lineage, especially in scenarios involving high-value goods (e.g., luxury watches, collectible handbags, art pieces). Additionally, brands or insurance providers may request proof of continuous custody before issuing or honoring warranty claims, insurance policies, and/or appraisals. The embodiments disclosed herein help reduce fraud and simplify claim verifications by linking NFC-based authentication to an immutable or secure ownership log.

In some embodiments, architecture 100 may enable partial or selective disclosure of chain-of-ownership data. For instance, a brand may choose to share only relevant events (e.g., such as repairs performed by an authorized service provider) while keeping the identity of specific owners confidential. This flexible approach helps ensure compliance with privacy regulations while still providing a robust and trustworthy record of ownership and physical object provenance.

Architecture 100 may enable royalty enforcement or analytics by leveraging the ownership log. The original brand may receive a notification each time the chain-of-ownership is updated. The maintained chain-of-ownership information in the ownership log may allow the brand to claim secondary-sale royalties, gather sales analytics on item longevity and resale demand, and further engage new owners through post-sale communications or brand loyalty programs.

In some embodiments, architecture 100 may be configured to store and verify compliance data from a point in time that the NFC chip is embedded in the physical object. The compliance data may be stored in a database (e.g., database 106 and/or database 205). During manufacturing, for example, factory identification codes, lot numbers, certification dates, and/or material sourcing details may be recorded in association with the NFC identifier as compliance data. Each time a physical object is authenticated by scanning the NFC chip (e.g., whether during a resale listing, a warranty claim, or a routine inspection), architecture 100 may validate whether the stored compliance information remains accurate and up-to-date.

By maintaining compliance data, the marketplace may aid in streamlining cross-border shipping processes, verifying import/export compliance, and/or simplifying the retrieval of item-specific regulatory certificates. Should a recall or safety advisory be issued, architecture 100 may rapidly identify all affected units based on their NFC-linked compliance records, notify current owners, and/or facilitate the necessary remediation steps.

Certain industries (e.g., pharmaceuticals, medical devices) may be subject to heightened regulatory scrutiny and data-handling requirements. In one embodiment, architecture 100 may ensure that only permissible fields of data are stored or shared in compliance with applicable privacy laws (e.g., General Data Protection Regulation (GDPR), California Consumer Privacy Act (CCPA)). In another embodiment, architecture 100 may manage user consent and limit data retention in accordance with jurisdiction-specific regulations by segregating compliance data and chain-of-ownership records. As a result, the marketplace can extend beyond traditional retail goods into regulated verticals while continuously enforcing data governance policies.

In some embodiments, manufacturers and/or authorized service providers may push updated warranty status or coverage information to the stored compliance data and chain-of-ownership information. Updates may be provided in industries where warranties or extended service plans apply. When a physical object is transferred, for example, the new owner may inherit the updated warranty details linked to the NFC identifier, eliminating the need for paper-based proofs or manual verifications. The ability to track and transfer warranties helps reduce fraudulent warranty claims and provides a more seamless post-sale service experience.

In some embodiments, architecture 100 may be configured to integrate with existing third-party marketplaces. The integration may enable established marketplaces to leverage the authentication, product information, and/or royalty distribution capabilities of architecture 100 without requiring sellers and buyers to migrate to a new platform. The third-party marketplace integration may allow products to be shipped directly from seller to buyer without having to be shipped to the marketplace platform to be manually inspected and authenticated.

Architecture 100 may interface with external marketplaces through a dedicated integration layer. The integration layer may comprise:
authentication API endpoints for receiving and processing NFC scan data from external marketplace applications;
product information delivery services that return comprehensive product details upon successful authentication;
royalty tracking and distribution mechanisms that operate across marketplace boundaries; and/or
dashboard interfaces specialized for marketplace partners.

The authentication API may be configured to receive authentication requests from external marketplace applications. Each authentication request may include an identifier obtained by scanning a physical object. The authentication API may be configured to process authentication of physical objects based on the received identifiers, and transmit product information and authentication results to the external marketplace applications. The royalty tracking and distribution mechanisms may be configured to record sales of authenticated physical objects occurring on external marketplaces, calculate royalty distributions for brands based on the recorded sales, and facilitate payments to brands based on the calculated royalty distributions. The dashboard interfaces may provide brand-specific views displaying secondary sales data aggregated across multiple external marketplaces, and marketplace-specific views displaying authentication and sales metrics specific to each external marketplace.

Throughout this entire process, the admin control panel may allow platform administrators to monitor user activity, moderate listings, and handle any customer support issues that may arise. In some embodiments, the admin control panel may allow administrators to modify listings. The API continues to facilitate communication and data exchanges between the various components, ensuring a seamless user experience.

By leveraging the capabilities of NFC technology and integrating with external brand websites, the marketplace streamlines the listing and authentication process, enhances trust and transparency, and provides a superior user experience for both buyers and sellers in the secondary sales market. The marketplace's ability to seamlessly integrate with external brand websites, such as e-commerce platforms and verification portals, enhances the accuracy and reliability of product information. By establishing direct communication channels with brand websites through APIs, the marketplace may automatically populate product details, specifications, and images in its catalog, ensuring that listings are consistent and up-to-date. Further, the marketplace is able to capture royalties on behalf of the brand that originally created the product being sold. Since each listing is verified via NFC chip scan, each transaction can be tracked, and brands can participate in the economics of authenticated resale of their products. Further, as a result of the NFC-enabled authentication process, direct communication channels can be established with the brand websites, meaning information on the buyer of the listed product could be communicated to the original brand of the listed product. Once the brand has been alerted that the product has changed hands, the brand may also push new content to the NFC chip welcoming the buyer to the brand, and encouraging the buyer to enter contact information.

This level of integration is not commonly found in existing secondary sales marketplaces, which often rely on manual input from sellers, leading to inconsistencies and inaccuracies. Creating listings by scanning NFC chips is a significant departure from the manual listing process employed by traditional online marketplaces. By allowing sellers to initiate the listing process simply by scanning the NFC chip on their product, the embodiments described herein simplify and streamline the listing creation workflow. The marketplace may automatically retrieves relevant product information from its database and prompts the seller to input only essential details, such as price and condition. This unique feature not only saves time for sellers but also ensures a higher level of accuracy and consistency across listings, enhancing the overall user experience.

The embodiments described herein may use NFC technology and its integration with external brand platforms which enable it to offer a more scalable and cost-effective solution compared to existing online consignment and “deadstock” models. The embodiments described herein offer more trust and security to users than legacy peer-to-peer marketplaces. By eliminating the need for in-house authentication and grading, the marketplace reduces operational overhead and lowers take rates for sellers. This makes the marketplace platform more accessible and attractive to a wider range of users, promoting greater participation and liquidity in the secondary sales market. The scalability and cost-effectiveness of the approach described herein are significant advantages over existing solutions, which often struggle with high costs and limited market reach.

Below is a summary of the tables in the schema and how they relate to each other. The schema is the description of the objects in the database. The schema defines the data model for an e-commerce platform focused on selling authenticated products. The key tables include:
5.1. users—stores user account information. Each user can have multiple roles through the user_roles association table.
5.2. brands—represents product brands. Each brand can have multiple products.
5.3. products—stores details about each product, including description, brand, and primary image. Products have different variants stored in product_variants table.
5.4. product_variants—represents different variations of a product, such as size or color. Product variants are associated with product_variant_images.
5.5. listings—represents a specific product variant listed for sale by a user. Listings are associated with a user, product_variant, price, condition, and authentication scan.
5.6. images—stores image data and metadata. Images are polymorphically associated with brands, products, product_variants, and listings.
5.7. scans—represents authentication scans performed on listings. Each scan stores raw scan data, current state, and any error messages. Detailed scan data is stored in the scan_data table.
5.8. stripe_accounts—stores Stripe account information and is associated with a user for payment processing.
5.9. checkouts—represents a checkout session for purchasing a listing. It is associated with a user, listing, and Stripe checkout session data.
5.10. stripe_webhooks—stores webhook events received from Stripe to keep financial data in sync.

The schema models the key entities and relationships for users to list authenticated products for sale, capture payments, and manage fulfillment. The data model enables an end-to-end e-commerce workflow while prioritizing product authenticity.

Below is an example of how the schema would represent a Bulgari Serpenti Forever Card Holder in emerald green and ivory:
5.11.1. A new record is inserted into the brands table with the name “Bulgari”.
5.11.2. A new record is inserted into the products table with the following attributes:
   name: “Serpenti Forever Card Holder”
   description: “The Serpenti Forever Card Holder in emerald green and ivory features a snakehead closure with black enamel eyes and a scaglie elaphe body. The interior includes four card slots and a removable mirror.”
   brand_id: references the “Bulgari” brand
   primary_image_id: references an image of the card holder

Two new records are inserted into the product_variants table, representing the emerald green and ivory color variations:
product_id: references the “Serpenti Forever Card Holder” product
attributes: JSON object specifying the color, e.g., {“color”: “emerald green”} and {“color”: “ivory”}
5.11.4. Images of the card holder in each color are inserted into the images table, with references stored in the product_variant_images table.
5.11.5. A user authenticates a Bulgari Serpenti Forever Card Holder and creates a new listing:
A new record is inserted into the scans table with the authentication scan data.
A new record is inserted into the listings table with the following attributes:
   user_id: references the user creating the listing
      product_variant_id: references the specific product variant being listed
      price: the listing price
      scan_id: references the authentication scan
      condition: the condition of the card holder

This example demonstrates how the schema efficiently captures the essential data points for listing an authenticated Bulgari Serpenti Forever Card Holder, including product details, variations, images, and authentication scans. The structured data model enables powerful querying, filtering, and product catalog management capabilities within the e-commerce platform.

Below is a high-level overview of the API routes and their functionality. The API routines may be used to execute the embodiments described herein:
6.1. ‘/stripeAccounts’: Handles operations related to Stripe accounts, such as creating, updating, or retrieving account information.
6.2. ‘/auth/[ . . . nextauth]’: Implements authentication using the NextAuth library, handling login, logout, and other authentication-related tasks.
6.3. ‘/admin/product/scrape/margiela’, ‘/admin/product/scrape/dior’, and ‘/admin/product/scrape/bulgari’: Handle scraping product information from the respective brands' websites (Margiela, Dior, and Bulgari) and storing the scraped data in the database.
6.4. ‘/product-variant/[id]’: Handles operations related to product variants, such as retrieving, updating, or deleting a specific product variant.
6.5. ‘/scan’ and ‘/scan/[id]’: Handle product authentication scans. The ‘/scan’ route may create a new scan, while ‘/scan/[id]’ retrieves, updates, or deletes a specific scan.
6.6. ‘/scan/[id]/match’: Performs a matching operation for a specific scan, reaching out to the third party verification site for authenticity verification.
6.7. ‘/image’ and ‘/image/[id]’: Handle image-related operations, such as uploading, retrieving, updating, or deleting images.
6.8. ‘/listing’, ‘/listing/[id]’, ‘/listing/[id]/delist’, and ‘/listing/[id]/checkout’: Manage product listings. The ‘/listing’ route may create a new listing, while ‘/listing/[id]’ retrieves, updates, or deletes a specific listing. The ‘/listing/[id]/delist’ route handles delisting a product, and ‘/listing/[id]/checkout’ manages the checkout process for a specific listing.
6.9. ‘/stripe/webhook’: Handles incoming webhook events from Stripe, such as notifications for successful payments, refunds, or other account-related events.

These API routes collectively enable the following high-level functionalities:
Product management: Scraping product information from brand websites, managing product variants, and handling product images.
Authentication: Implementing user authentication and authorization using NextAuth.
Product authentication: Handling product authentication scans and matching them with the product database.
Listings and transactions: Managing product listings, delisting products, and handling the checkout process.
Stripe integration: Managing Stripe accounts and handling webhook events for payments and other account-related activities.

The API routes follow a RESTful design pattern, utilizing HTTP methods (GET, POST, PUT, DELETE) to perform operations on resources. The use of dynamic route segments (e.g., ‘[id]’) allows for handling specific resources based on their unique identifiers.

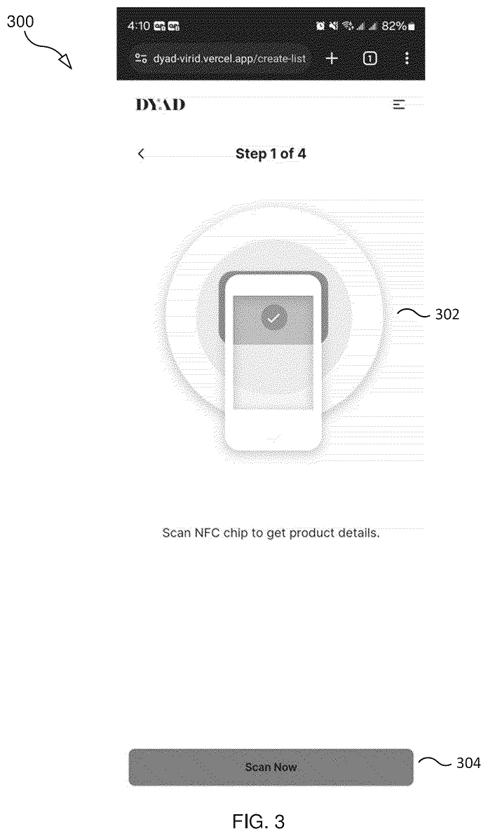

FIGS. 3-9 show diagrams illustrating a user interface for listing a physical object according to some embodiments. FIG. 3 illustrates a user interface 300 when a seller first begins the process of listing a physical object on the marketplace using their device (e.g., smart phone). User interface 300 may include instruction diagram 302 indicating the seller should place their device next to the physical object to scan the NFC chip and obtain product details. The bottom of user interface 300 includes a scan now button 304 which the seller can press to scan the NFC chip within the physical object.

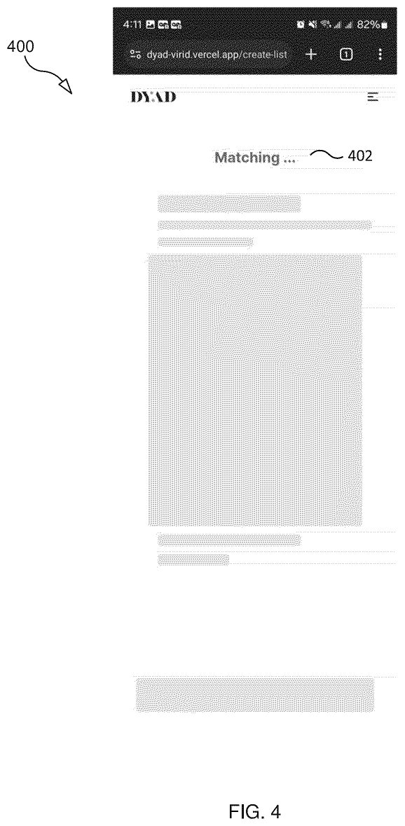

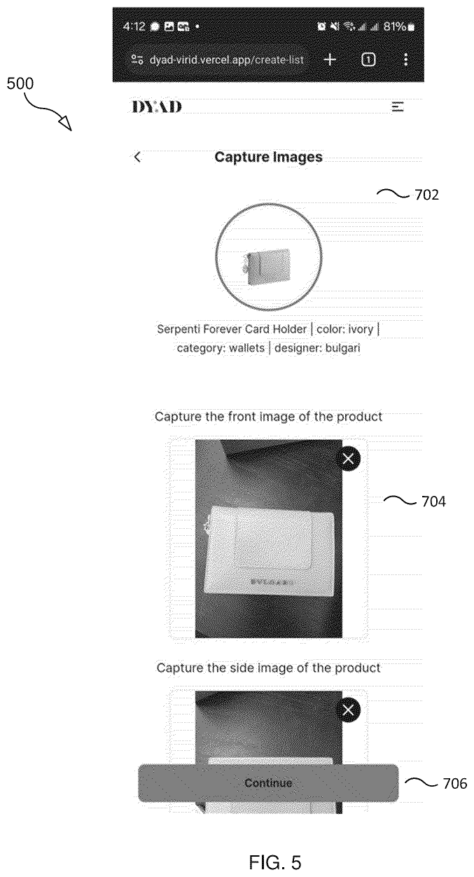

FIG. 4 illustrates a user interface 400 after seller has scanned the physical object. Interface 400 provides a matching animation indicating to the user the marketplace is matching the scanned information to entry in its database. If the physical object is authenticated by the marketplace, user interface 500 is displayed on seller's device. FIG. 5 illustrates a user interface 500. User interface 500 includes an authentic indication 502 indicating the physical object is authentic. User interface 500 also includes an information graphic display 504. Information graphic display 504 may include information the marketplace already obtained related to the physical object. The information may be obtained from the original retailer or brand and may include, for example, an image of the object, the name of the object, a color of the object, a category of the object, and the designer of the object. User interface 500 also comprises a “it's correct” button 506 which allows the seller to confirm that the information in the information graphic display is correct.

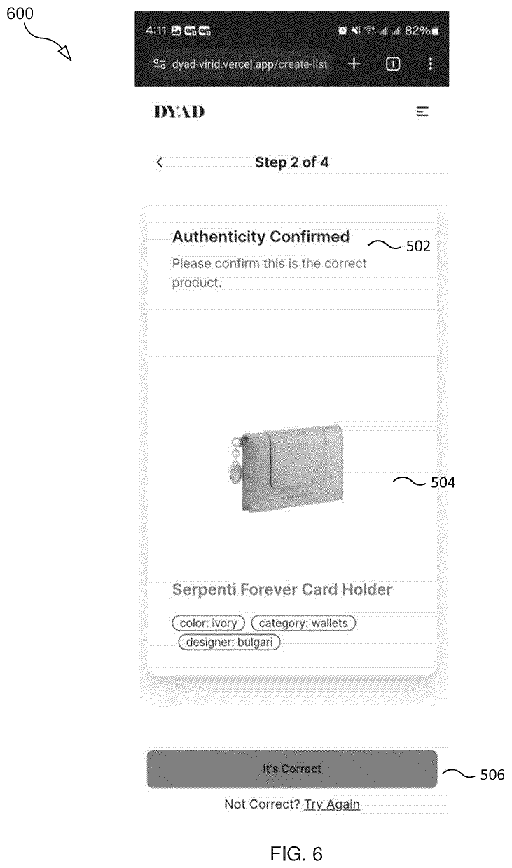

After the seller confirms the information is correct, they are directed to user interface 600. FIG. 6 illustrates user interface 600. User interface 600 comprises a description graphic 602, a price box 604, a condition box 606, and a continue button 608. Description graphic 602 displays the correct descriptive information to the user. Price box 604 allows the user to set a price for the physical object. Condition box 606 allows the user to set the condition of the physical object. Once this information is entered, a user may progress by pressing the continue button 608.

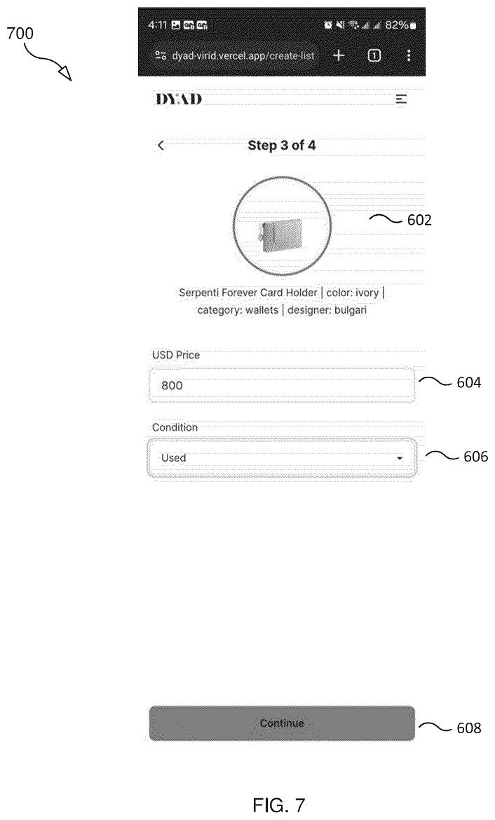

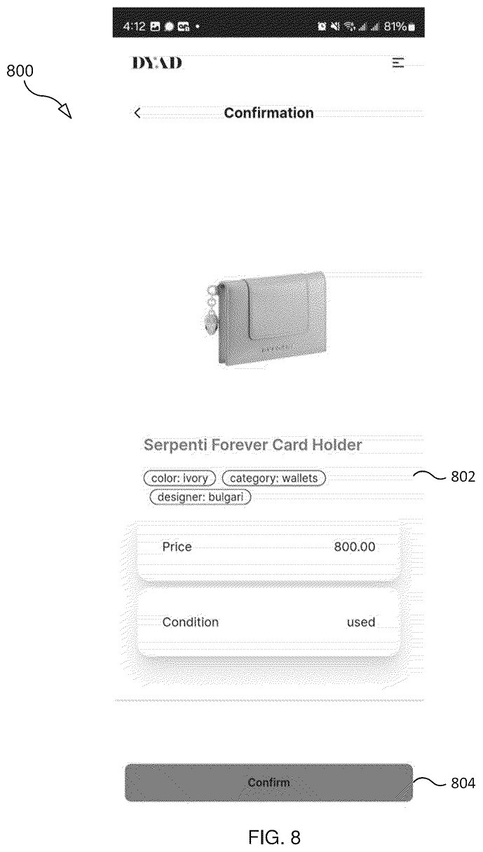

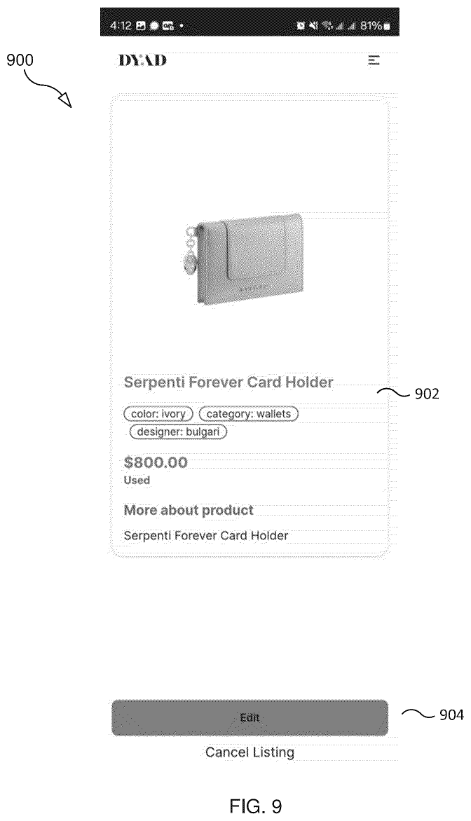

FIG. 7 illustrates user interface 700. User interface 700 prompts the user to photograph the physical object with prompt 702. The images are displayed on user interface 700 at photo display 704. After the user is satisfied with the photos, they may progress by selecting the continue button 706. FIG. 8 illustrates user interface 800. User interface 800 prompts the user to confirm the information is correct. User interface 800 comprises an information graphic 802 displaying the information related to the physical object for the listing and a confirm button 804. After the user confirms the information is correct, they are brought to user interface 900. FIG. 9 illustrates user interface 900. This interface displays the listing 902 and provides an edit butter 904 for the user to edit the listing.

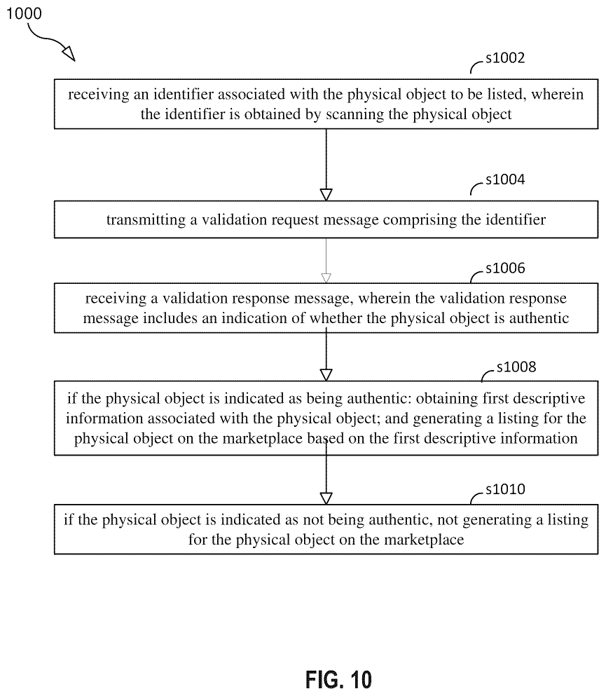

FIG. 10 is a flow chart illustrating a computer-implemented method 1000 for listing a physical object on a marketplace according to some embodiments. Method 1000 may begin with step s1002.

Step s1002 comprises receiving an identifier associated with the physical object to be listed, wherein the identifier is obtained by scanning the physical object.

Step s1004 comprises transmitting a validation request message comprising the identifier.

Step s1006 comprises receiving a validation response message, wherein the validation response message includes an indication of whether the physical object is authentic.

Step s1008 comprises, if the physical object is indicated as being authentic: obtaining first descriptive information associated with the physical object; and generating a listing for the physical object on the marketplace based on the first descriptive information.

Step s1010 comprises, if the physical object is indicated as not being authentic, not generating a listing for the physical object on the marketplace.

In some embodiments, the computer-implemented method further comprises, prior to receiving the identifier, retrieving the first descriptive information from a third party, wherein the third party is associated with the physical object; and storing the first descriptive information in a database, wherein obtaining the first descriptive information associated with the physical object comprises retrieving the first descriptive information from the database.

In some embodiments, retrieving the first descriptive information from the third party comprises scraping a website associated with the third party. In some embodiments, the validation message is transmitted to a device associated with the third party. In some embodiments, obtaining the first descriptive information comprises: after receiving the validation response message, retrieving the first descriptive information from a third party, wherein the third party is associated with the physical object.

In some embodiments, the computer-implemented method further comprises, if the physical object is indicated as being authentic: transmitting a request for second descriptive information; receiving the second descriptive information; and including the second descriptive information in the listing.

In some embodiments, the second descriptive information comprises a price, a condition of the physical object, and an image of the physical object.

In some embodiments, the computer-implemented method further comprises receiving a modification request, wherein the modification request indicates a modification to the listing.

In some embodiments, the physical object includes a near-field communication (NFC) chip and the identifier is obtained by a computing device scanning the NFC chip of the physical object. In some embodiments, the validation response message includes a unique unit identifier.

In some embodiments, the computer-implemented method further comprises determining whether another listing is associated with the unique unit identifier.

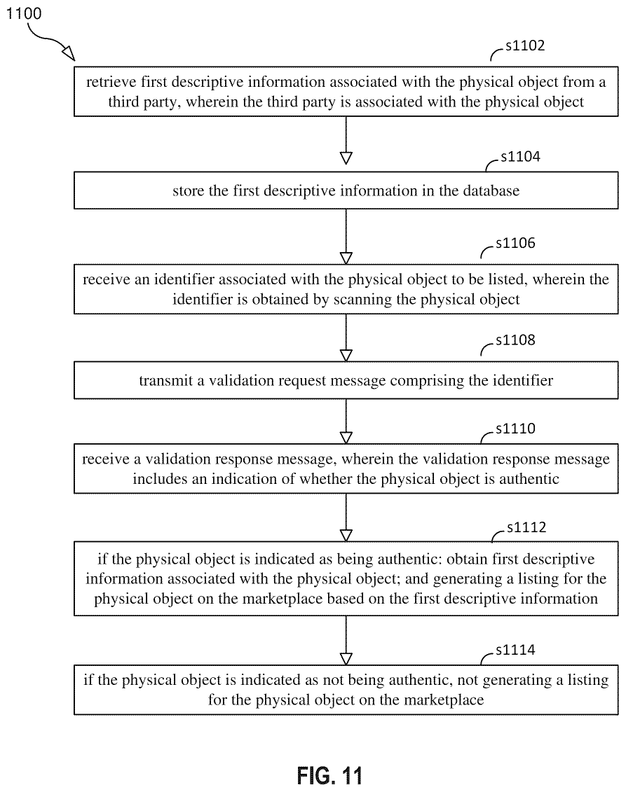

FIG. 11 is a flow chart illustrating a computer-implemented method 1100 for listing a physical object on a marketplace according to some embodiments. Method 1100 may be performed by a system comprising a database, a controller, and an API.

Step s1102 comprises to retrieve first descriptive information associated with the physical object from a third party. The third party is associated with the physical object. Step s1104 comprises to store the first descriptive information in the database.

Step s1106 comprises to receive an identifier associated with the physical object to be listed. The identifier is obtained by scanning the physical object.

Step s1108 comprises to transmit a validation request message comprising the identifier.

Step s1110 comprises to receive a validation response message. The validation response message includes an indication of whether the physical object is authentic.

Step s1112 comprises to, if the physical object is indicated as being authentic, obtain the first descriptive information associated with the physical object from the database.

Step s1112 comprises to, if the physical object is indicated as being authentic, generate a listing for the physical object on the marketplace based on the first descriptive information.

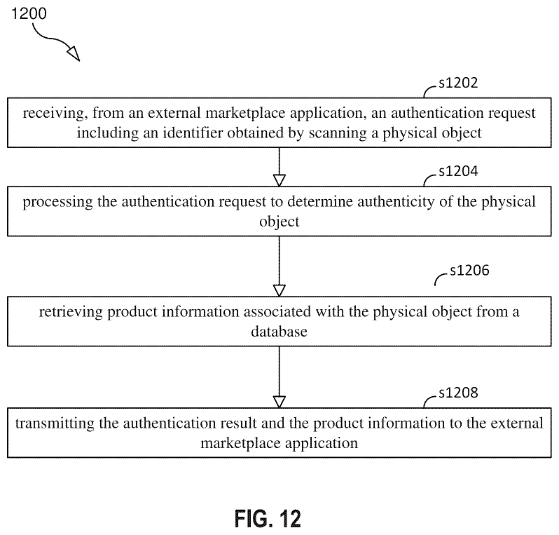

FIG. 12 is a flow chart illustrating a computer-implemented method 1200 for providing authentication services to external marketplaces according to some embodiments. Method 1200 may begin with step s1202.

Step s1202 comprises receiving, from an external marketplace application, an authentication request including an identifier obtained by scanning a physical object.

Step s1204 comprises processing the authentication request to determine authenticity of the physical object.

Step s1206 comprises retrieving product information associated with the physical object from a database.

Step s1208 comprises transmitting the authentication result and the product information to the external marketplace application.

In some embodiments, method 1200 further comprises receiving, from the external marketplace application, a notification of a completed sale of the physical object, calculating a royalty amount due to a brand associated with the physical object, and distributing the royalty amount to the brand.

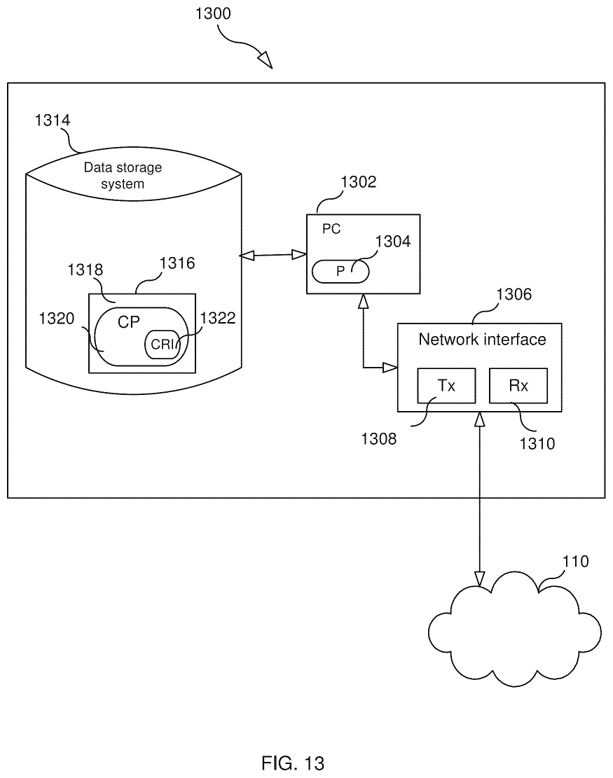

FIG. 13 is a block diagram of an apparatus 1300, according to some embodiments. As shown in FIG. 13, the apparatus may comprise: processing circuitry (PC) 1302, which may include one or more processors (P) 1355 (e.g., a general purpose microprocessor and/or one or more other processors, such as an application specific integrated circuit (ASIC), field-programmable gate arrays (FPGAs), and the like); a network interface 1348 comprising a transmitter (Tx) 1345 and a receiver (Rx) 1347 for enabling the apparatus to transmit data to and receive data from other computing devices connected to a network 1310 (e.g., an Internet Protocol (IP) network) to which network interface 1348 is connected; and a local storage unit (a.k.a., “data storage system”) 1308, which may include one or more non-volatile storage devices and/or one or more volatile storage devices. In embodiments where PC 1302 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like.

In some embodiments, apparatus 1300 may comprise and/or perform the functions of any computing devices, APIs, and objects described in FIGS. 1-12. In some embodiments, the CRI 1344 of computer program 1343 is configured such that when executed by PC 1302, the CRI 1344 causes the apparatus 1300 to perform steps/functions described herein (e.g., steps/functions described herein with reference to FIGS. 2-12). In other embodiments, the apparatus 1300 may be configured to perform steps/functions described herein without the need for code. That is, for example, PC 1302 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### CONCISE DESCRIPTION OF CERTAIN EMBODIMENTS

### Group A Embodiments

A1. A computer-implemented method for listing a physical object on a marketplace, the method comprising:
receiving an identifier associated with the physical object to be listed, wherein the identifier is obtained by scanning the physical object;
transmitting a validation request message comprising the identifier;
receiving a validation response message, wherein the validation response message includes an indication of whether the physical object is authentic; and
if the physical object is indicated as being authentic:
   obtaining first descriptive information associated with the physical object; and
   generating a listing for the physical object on the marketplace based on the first descriptive information.

A2. The computer-implemented method according to embodiment A1, further comprising:
prior to receiving the identifier, retrieving the first descriptive information from a third party, wherein the third party is associated with the physical object; and
storing the first descriptive information in a database, wherein obtaining the first descriptive information associated with the physical object comprises retrieving the first descriptive information from the database.

A3. The computer-implemented method according to embodiment A2, wherein retrieving the first descriptive information from the third party comprises scraping a website associated with the third party.

A4. The computer-implemented method according to embodiment A2, wherein the validation message is transmitted to a device associated with the third party.

A5. The computer-implemented method according to embodiment A1, wherein obtaining the first descriptive information comprises:
after receiving the validation response message, retrieving the first descriptive information from a third party, wherein the third party is associated with the physical object.

A6. The computer-implemented method according to embodiment A1, further comprising if the physical object is indicated as being authentic:
transmitting a request for second descriptive information;
receiving the second descriptive information; and
including the second descriptive information in the listing.

A7. The computer-implemented method according to embodiment A6, wherein the second descriptive information comprises a price, a condition of the physical object, and an image of the physical object.

A8. The computer-implemented method according to embodiment A1, further comprising:
receiving a modification request, wherein the modification request indicates a modification to the listing.

A9. The computer-implemented method according to embodiment A1, wherein the physical object includes a near-field communication (NFC) chip and the identifier is obtained by a computing device scanning the NFC chip of the physical object.

A10. The computer-implemented method according to embodiment A1, wherein the identifier is obtained by performing an optical scan of the physical object.

A11. The computer-implemented method according to embodiment A1, wherein the validation response message includes a unique unit identifier.

A12. The computer-implemented method according to embodiment A11, further comprising:
determining whether another listing is associated with the unique unit identifier.

A13. The computer-implemented method according to embodiment A1, wherein the validation response message includes:
an indication of whether a digital certificate associated with the physical object is authentic, and/or
an indication of whether the digital certificate is associated with a seller of the physical object.

A14. The computer-implemented method according to embodiment A1, further comprising:
receiving an indication of a sale related to the physical object; and
updating an ownership log with the indication of the sale and the identifier.

A15. The computer-implemented method according to embodiment A1, further comprising:
receiving regulatory data associated with the physical object;
receiving an indication of a sale related to the physical object; and
in response to receiving the indication of the sale, validating the regulatory data.

### Group B Embodiments

B1. A system for listing a physical object on a marketplace, the system comprising:
a database;
a controller, wherein the controller is configured to:
   retrieve first descriptive information associated with the physical object from a third party, wherein the third party is associated with the physical object; and
   store the first descriptive information in the database;
an application programming interface (API), where in the API is configured to:
   receive an identifier associated with the physical object to be listed, wherein the identifier is obtained by scanning the physical object;
   transmit a validation request message comprising the identifier;
   receive a validation response message, wherein the validation response message includes an indication of whether the physical object is authentic; and
   if the physical object is indicated as being authentic:
      obtain the first descriptive information associated with the physical object from the database; and
      generate a listing for the physical object on the marketplace based on the first descriptive information.

### Group C Embodiments

C1. A system for enabling authentication and listing of physical objects across multiple marketplaces, the system comprising:
a database comprising product information, wherein the product information is associated with a physical object;
an application programming interface (API); and
a computing device, wherein the API is configured to:
   receive an authentication request from an external marketplace application, wherein the authentication request includes an identifier obtained by scanning the physical object;
   obtain authentication information related to the physical object based on the identifier;
   transmit product information and authentication information associated with the physical object to the external marketplace application.

C2. The system of claim C1, further comprising a multi-tenant dashboard providing:
brand-specific views displaying secondary sales data aggregated across multiple external marketplaces; and
marketplace-specific views displaying authentication and sales metrics specific to each external marketplace.

C3. The system of claim C1, further comprising a royalty tracking module configured to:
record sales of authenticated physical objects occurring on external marketplaces;
calculate royalty distributions for brands based on the recorded sales; and
facilitate payments to brands based on the calculated royalty distributions

C4. A computer-implemented method for providing authentication services to external marketplaces, the method comprising:
receiving, from an external marketplace application, an authentication request including an identifier obtained by scanning a physical object;
processing the authentication request to determine authenticity of the physical object;
retrieving product information associated with the physical object from a database;
transmitting the authentication result and the product information to the external marketplace application;
receiving, from the external marketplace application, a notification of a completed sale of the physical object;
calculating a royalty amount due to a brand associated with the physical object; and
distributing the royalty amount to the brand.

### Group D Embodiments

D1. A device used for listing a physical object on a marketplace, the device comprising:
one or more memories comprising instruction data representing a set of instructions; and
one or more processors configured to communicate with the one or more memories and to execute the set of instructions, wherein the set of instructions, when executed by the processor, cause the one or more processors to perform the methods of Group A embodiments.

D2. A computer program comprising instructions which, when executed by processing circuitry, causes the processing circuitry to carry out the methods of Group A embodiments.

D3. A carrier containing a computer program according to embodiment D2, wherein the carrier comprises one of an electronic signals, optical signal, radio signal or computer readable storage medium.

D4. A computer program product comprising a non-transitory computer readable medium having stored thereon a computer program according to embodiment D2.

D5. An apparatus, the apparatus comprising:
a memory; and
processing circuitry coupled to the memory, wherein the apparatus is configured to perform the methods of any one of the preceding Group A embodiments.

1. A computer-implemented method for listing a physical object on a marketplace, the method comprising:
receiving an identifier associated with the physical object to be listed, wherein the identifier is obtained by scanning the physical object;
transmitting a validation request message comprising the identifier;
receiving a validation response message, wherein the validation response message includes an indication of whether the physical object is authentic; and
if the physical object is indicated as being authentic:
obtaining first descriptive information associated with the physical object; and
generating a listing for the physical object on the marketplace based on the first descriptive information.

2. The computer-implemented method according to claim 1, further comprising:
prior to receiving the identifier, retrieving the first descriptive information from a third party, wherein the third party is associated with the physical object; and
storing the first descriptive information in a database, wherein obtaining the first descriptive information associated with the physical object comprises retrieving the first descriptive information from the database.

3. The computer-implemented method according to claim 2, wherein retrieving the first descriptive information from the third party comprises scraping a website associated with the third party.

4. The computer-implemented method according to claim 2, wherein the validation message is transmitted to a device associated with the third party.

5. The computer-implemented method according to claim 1, wherein obtaining the first descriptive information comprises:
after receiving the validation response message, retrieving the first descriptive information from a third party, wherein the third party is associated with the physical object.

6. The computer-implemented method according to claim 1, further comprising if the physical object is indicated as being authentic:
transmitting a request for second descriptive information;
receiving the second descriptive information; and
including the second descriptive information in the listing.

7. The computer-implemented method according to claim 6, wherein the second descriptive information comprises a price, a condition of the physical object, and an image of the physical object.

8. The computer-implemented method according to claim 1, further comprising:
receiving a modification request, wherein the modification request indicates a modification to the listing.

9. The computer-implemented method according to claim 1, wherein the physical object includes a near-field communication (NFC) chip and the identifier is obtained by a computing device scanning the NFC chip of the physical object.

10. The computer-implemented method according to claim 1, the identifier is obtained by performing an optical scan of the physical object.

11. The computer-implemented method according to claim 1, wherein the validation response message includes a unique unit identifier.

12. The computer-implemented method according to claim 11, further comprising:
determining whether another listing is associated with the unique unit identifier.

13. The computer-implemented method according to claim 1, wherein the validation response message includes:
an indication of whether a digital certificate associated with the physical object is authentic, and/or
an indication of whether the digital certificate is associated with a seller of the physical object.

14. The computer-implemented method according to claim 1, further comprising:
receiving an indication of a sale related to the physical object; and
updating an ownership log with the indication of the sale and the identifier.

15. The computer-implemented method according to claim 1, further comprising:
receiving regulatory data associated with the physical object;
receiving an indication of a sale related to the physical object; and
in response to receiving the indication of the sale, validating the regulatory data.

16. A system for listing a physical object on a marketplace, the system comprising:
a database;
a controller, wherein the controller is configured to:
retrieve first descriptive information associated with the physical object from a third party, wherein the third party is associated with the physical object; and
store the first descriptive information in the database;
an application programming interface (API), wherein the API is configured to:
receive an identifier associated with the physical object to be listed, wherein the identifier is obtained by scanning the physical object;
transmit a validation request message comprising the identifier;
receive a validation response message, wherein the validation response message includes an indication of whether the physical object is authentic; and
if the physical object is indicated as being authentic:
obtain the first descriptive information associated with the physical object from the database; and
generate a listing for the physical object on the marketplace based on the first descriptive information.

17. A computer-implemented method for providing authentication services to external marketplaces, the method comprising:
receiving, from an external marketplace application, an authentication request including an identifier obtained by scanning a physical object;
processing the authentication request to determine authenticity of the physical object;
retrieving product information associated with the physical object from a database; and
transmitting the authentication result and the product information to the external marketplace application.

18. The computer-implemented method according to claim 17, further comprising:
receiving, from the external marketplace application, a notification of a completed sale of the physical object;
calculating a royalty amount due to a brand associated with the physical object; and
distributing the royalty amount to the brand.

19. The computer-implemented method according to claim 1, wherein the validation request message comprises at least one of:
a request to determine whether there is a digital certificate associated with the physical object,
a request to determine whether the digital certificate is authentic, and
a request to determine whether a user owns the certificate.
